(19) United States
(12) Patent Application Publication
(10) Pub. No.: US 2006/0045474 A1
(43) Pub. Date: Mar. 2, 2006

(54) Video reproducing apparatus, remote controller for controlling the apparatus, and method for converting channels of the apparatus

(75) Inventor: Jung-kil Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD

(21) Appl. No.: 11/153,329

(22) Filed: Jun. 16, 2005

(30) Foreign Application Priority Data
Aug. 26, 2004 (KR) 10-2004-0067370

(51) Int. Cl. H04N 5/783

(52) U.S. Cl. 386/69; 386/83

(57) ABSTRACT

Disclosed are a video reproducing apparatus, a remote controller for controlling the apparatus, and a method for converting channels of the apparatus that can achieve a fast and easy channel selection through a plural-channel switchover. The video reproducing apparatus includes a key input unit, having a plurality of function keys, including a channel increase key and a channel decrease key, which apply request signals corresponding to the function keys, a channel converting unit, which converts a present channel to a desired channel number, and a control unit, which controls the channel converting unit so as to convert the present channel according to a specified separation of channel switchover if a plural-channel switchover request signal for converting the channel according to the specified separation of channel switchover is input from the key input unit.

### CROSS-REFERENCE TO RELATED APPLICATIONS

This application claims benefit under 35 U.S.C. § 119 from Korean Patent Application No. 10-2004-0067370 filed on Aug. 26, 2004, the entire content of which is incorporated herein by reference.

### BACKGROUND OF THE INVENTION

1. Field of the Invention

The present invention relates to a video reproducing apparatus, a remote controller for controlling the apparatus, and a method for converting channels of the apparatus, which can convert the channels of the video reproducing apparatus at a desired speed of a channel switchover.

2. Description of the Related Art

According to conventional methods, in order to change a present channel number of a video reproducing apparatus to a higher channel number, a user must repeatedly press a channel increase key until the desired channel appears. Also, in order to change the present channel number to a lower channel number, the user must repeatedly press a channel decrease key until the desired channel appears. In both cases, the channel number is changed one by one by pressing the channel increase key or the channel decrease key, respectively.

Alternatively, when the user knows the desired channel number, the user may directly convert the channel to the desired channel number by pressing numeral keys corresponding to the channel number.

Such conventional methods for successively converting the channels one by one may not cause any problem in a general broadcasting system having a small number of channels. However, as the number of broadcasting stations has increased, and as the broadcasting environment has changed from an analog broadcasting environment to a digital broadcasting environment, a large number of channels have been produced, and conventional methods are disadvantageous in converting the large number of channels.

For example, about 100 channels are used in many current cable broadcasting environments, and most users who cannot memorize all of the channels must search for their desired channels by repeatedly converting the channels one by one using the channel increase key and the channel decrease key.

Additionally, in a digital broadcasting environment, because the virtual channel numbers would be changed from time to time, and because one broadcasting signal can be broadcast simultaneously through several channels, the number of channels has gradually increased to several hundred channels. In converting such several hundred channels, it is difficult for the users to memorize all of the channels or to search for their desired channels by converting the channels one by one.

As a scheme for converting the channels more easily, a remote controller provided with a slow channel up/down key and a fast channel up/down key for adjusting the speed of the channel switchover has been proposed. This remote controller, however, has a drawback in that a separate slow channel up/down key and a separate fast channel up/down key must be provided in the remote controller to thereby achieve only two speeds of the channel switchover.

### SUMMARY OF THE INVENTION

Exemplary embodiments of the present invention have been developed to overcome the above disadvantages and other disadvantages not described above that are associated with conventional arrangements. Also, the present invention is not required to overcome the disadvantages described above, and an illustrative, non-limiting embodiment of the present invention may not overcome any of the problems described above.

An aspect of the present invention is to provide a video reproducing apparatus, a remote controller for controlling the apparatus, and a method for converting channels of the apparatus, which can convert the channels of the video reproducing apparatus at a desired speed of channel switchover through a simple key manipulation.

In order to achieve the above-described aspects of the present invention, and others, there is provided a video reproducing apparatus comprising a key input unit, having a plurality of function keys including a channel increase key and a channel decrease key, for applying request signals corresponding to the function keys, a channel converting unit for converting a present channel to a desired channel number, and a control unit for controlling the channel converting unit to convert the present channel according to a specified separation of channel switchover, if a plural-channel switchover request signal for converting the channel according to the specified separation of channel switchover is input from the key input unit.

The plural-channel switchover request signal may be applied to the control unit according to a specified length of time for which the channel increase key and/or the channel decrease key are continuously pressed. If the plural-channel switchover request signal is continuously applied for the specified time, the control unit increases the specified separation of channel switchover.

If the plural-channel switchover request signal is input, the control unit may operate to display channel information. For instance, the channel information displayed may include a channel number, after the channel is converted, and the separation of channel switchover.

In another aspect of the present invention, there is provided a remote controller of a video reproducing apparatus comprising a key input unit, having a plurality of function keys including a channel increase key, a channel decrease key, and directional keys, for applying request signals corresponding to the function keys, a control unit for generating a plural-channel switchover code for converting a present channel of the video reproducing apparatus according to a specified separation of channel switchover, if a plural-channel switchover request signal, for converting the channel according to the specified separation of channel switchover, is input from the key input unit, and a signal transmitting unit for transmitting the plural-channel switchover request signal from the control unit to the video reproducing apparatus.

The plural-channel switchover request signal may be applied to the control unit according to a specified length of time for which the channel increase key and/or the channel decrease key are continuously pressed. If the plural-channel switchover request signal is continuously applied for a specified length of time, after the plural-channel switchover code is created by the applied plural-channel switchover request signal, the control unit creates a new plural-channel switchover code, which increases the specified separation of channel switchover.

The directional keys may be provided in correspondence with upper, lower, left and right directions, and different separations of the channel switchover may be allocated to the respective directional keys. For example, the plural-channel switchover request signal may be applied by pressing both the channel increase/decrease keys and any one of the directional keys.

The key input unit may further include at least one high-speed channel switchover key for applying the plural-channel switchover request signal for converting the channel according to the allocated specified separation of channel switchover. For instance, the plural-channel switchover request signal may be applied by pressing either the channel increase key or the channel decrease key together with any one of the high-speed channel switchover keys.

If the plural-channel switchover request signal is input, the control unit may operate to create a channel information display code for displaying channel information through the video reproducing apparatus, and may transmit the channel information display code to the video reproducing apparatus through the signal transmitting unit. By way of illustration, the channel information displayed may include a channel number, after the channel is converted, and the separation of channel switchover.

In still another aspect of the present invention, there is provided a method for converting channels of a video reproducing apparatus comprising the operations of receiving an input of a plural-channel switchover request signal for converting the channels in correspondence to a specified separation of channel switchover, and for converting a present channel of the video reproducing apparatus according to the specified separation of channel switchover.

The method may further comprise the operation of increasing the specified separation of channel switchover, if the plural-channel switchover request signal is continuously applied for a specified length of time.

The method may further comprise the operation of displaying channel information through the video reproducing apparatus if the plural-channel switchover request signal is input. For example, the channel information may include a channel number, after the channel is converted, and the separation of channel switchover.

In still another aspect of the present invention, there is provided a method for converting channels of a video reproducing apparatus comprising the operations of receiving an input of a plural-channel switchover request signal for converting the channels according to a specified separation of channel switchover, generating a plural-channel switchover code for converting a present channel of the video reproducing apparatus according to the specified separation of channel switchover, and transmitting the created plural-channel switchover code to the video reproducing apparatus.

The method may further comprise the operation of generating a new plural-channel switchover code, which increases the separation of channel switchover if the plural-channel switchover request signal is continuously applied for a specified time.

The method may further comprise the operation of generating a channel information display code for displaying channel information through the video reproducing apparatus and transmitting the channel information display code to the video reproducing apparatus if the plural-channel switchover request signal is input. For example, the channel information may include a channel number, after the channel is switched, and the separation of channel switchover.

### BRIEF DESCRIPTION OF THE DRAWINGS

The above and other aspects of the present invention will be readily apparent by describing exemplary embodiments of the present invention with reference to the accompanying drawings, in which:

FIG. 1 is a view illustrating a connection between a video reproducing apparatus and a remote controller thereof;

FIG. 2 is a block diagram illustrating a video reproducing apparatus according to an exemplary embodiment of the present invention;

FIG. 3 is a view illustrating an example of channel information displayed through a video reproducing apparatus;

FIGS. 4A to 4C are views illustrating the exterior of a remote controller consistent with an exemplary embodiment of the present invention;

FIG. 5 is a block diagram of a remote controller consistent with an exemplary embodiment of the present invention;

FIG. 6 is a flowchart illustrating a channel converting method for a video reproducing apparatus consistent with an exemplary embodiment of the present invention; and

FIG. 7 is a flowchart illustrating a channel converting method for a remote controller consistent with an exemplary embodiment of the present invention.

### DETAILED DESCRIPTION OF EXEMPLARY EMBODIMENTS

The various aspects present invention will now be described in detail by describing certain exemplary embodiments thereof with reference to the accompanying drawings. In the following description, the same drawing reference numerals denote the same elements even in different drawings. The matters defined in the description, such as a detailed construction and elements, are nothing but examples provided to assist in a comprehensive understanding of the invention. Thus, it is apparent that the present invention can be carried out without those defined matters. Also, well-known functions and constructions are not described in detail since they would obscure the invention in unnecessary detail.

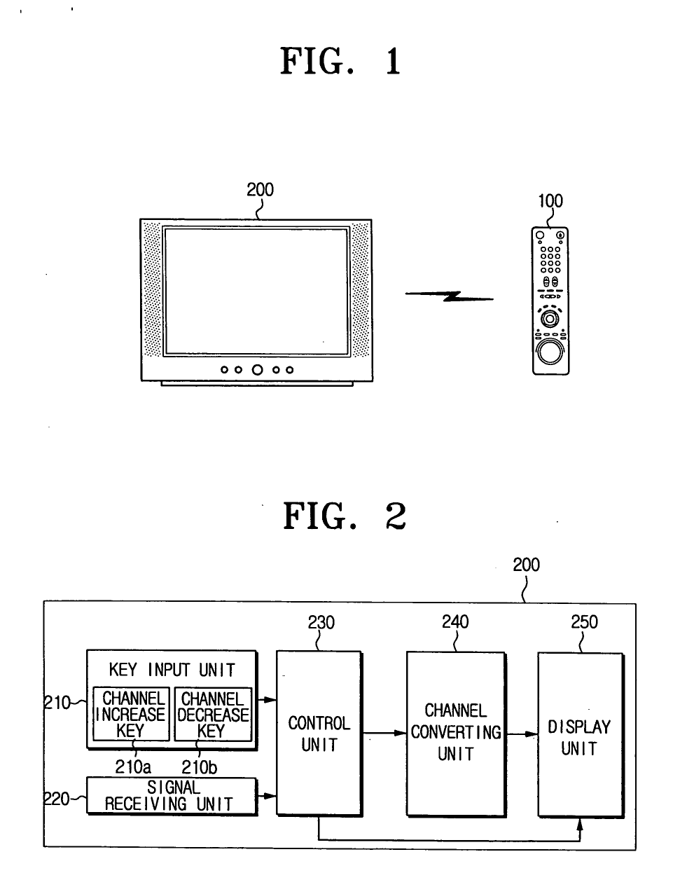

FIG. 1 is a view illustrating a video reproducing apparatus and a remote controller connected to the video reproducing apparatus.

A remote controller 100 remotely controls a video reproducing apparatus 200 by emitting an infrared signal, in response to a key manipulation by a user. Typically, the infrared signal from the remote controller 100 is a pulse signal in the frequency range of about 30 KHz to 40 KHz.

The video reproducing apparatus 200, which may be, for example, a television receiver, receives and reproduces video information so that a viewer can view the video information.

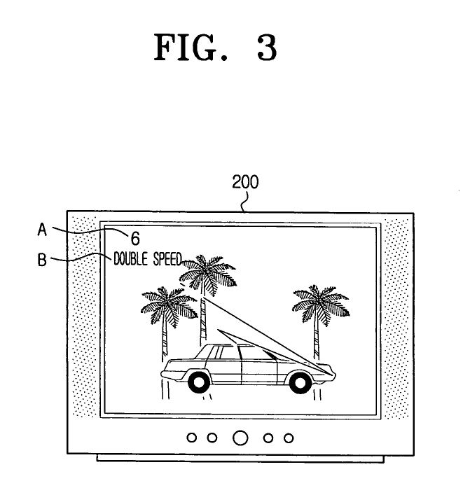

FIG. 2 is a block diagram illustrating a video reproducing apparatus according to an exemplary embodiment of the present invention.

The video reproducing apparatus 200 includes a key input unit 210, a signal receiving unit 220, a control unit 230, a channel converting unit 240, and a display unit 250.

The key input unit 210 has a plurality of function keys including a channel increase key 210a and a channel decrease key 210b, which are provided on a front panel of the video reproducing apparatus 200, and applies request signals corresponding to the respective function keys to the control unit 230. For instance, the request signals may include a plural-channel switchover request signal for converting channels according to a specified separation of channel switchover.

In one exemplary embodiment of the present invention, the plural-channel switchover request signal may be applied according to the length of time for which the channel increase key 210a and/or the channel decrease key 210b are continuously pressed.

The signal receiving unit 220 receives the infrared signal transmitted from the remote controller that remotely controls the video reproducing apparatus 200, converts the infrared signal into a signal that can be recognized by the video reproducing apparatus 200, and applies the converted signal to the control unit 230.

If a plural-channel switchover request signal is input from the signal receiving unit 220, the control unit 230 controls the channel converting unit 240 to convert the present channel according to a separation of channel switchover that is included in the plural-channel switchover request signal.

If the plural-channel switchover request signal from the key input unit 210 or the signal receiving unit 220 is continuously applied for a specified length of time, the control unit 230 increases the separation of channel switchover, and controls the channel converting unit 240 to convert the channel according to the increased separation for channel switchover.

If the plural-channel switchover request signal is applied from the key input unit 210 or the signal receiving unit 220, the control unit 230 controls the display unit 250 to display channel information including a channel number, after the channel is converted, and the separation of channel switchover, through the video reproducing apparatus.

Under the control of the control unit 230, the channel converting unit 240 converts the present channel to a specified channel number, and thus the display unit 250 displays the video information of the converted channel.

The display unit 250, under the control of the control unit 230, displays the video information of the present channel, and if the channel is converted by the channel converting unit 240, it displays the video information of the converted channel.

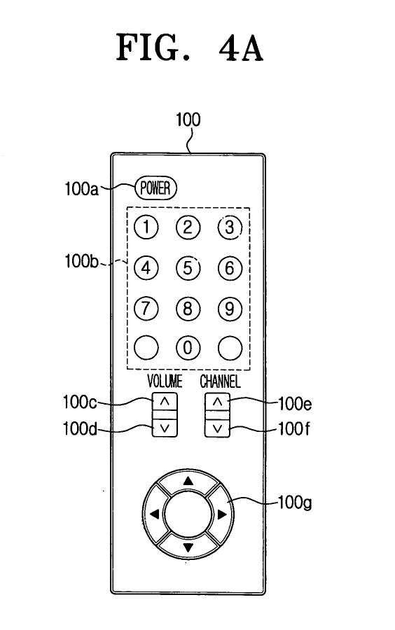

FIG. 3 is a view illustrating an example of the channel information displayed through the video reproducing apparatus.

If a control signal for displaying the channel information is received from the control unit 230, the display unit 250 displays the channel information, along with the video information of the converted channel according to the corresponding separation of channel switchover.

During the channel switchover, the display unit 250 may display only the present channel A. In one exemplary embodiment of the present invention, both the present channel A and the separation B of channel switchover are displayed in order to improve the user's convenience in use.

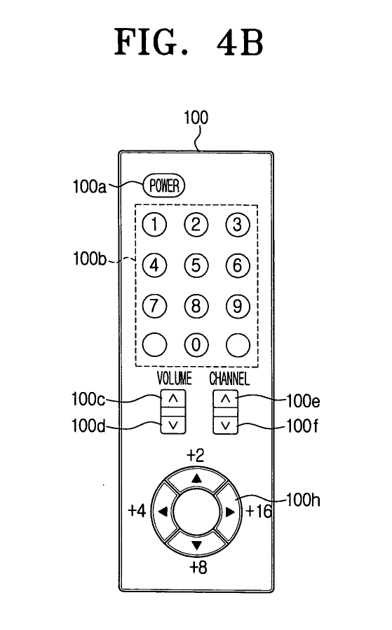

FIGS. 4A to 4C are views illustrating the exterior of the remote controller according to an exemplary embodiment of the present invention.

As illustrated in FIGS. 4A to 4C, the remote controller 100 typically includes a power supply key 100a for turning on/off the power supply to the video reproducing apparatus 200, numeral keys 100b for directly inputting numerals for channel numbers and various kinds of functions, a volume increase key 100c, and a volume decrease key 100d.

Additionally, the remote controller 100 includes a channel increase key 100e for increasing the channel number, a channel decreasing key 100f for decreasing the channel number, and directional keys 100g and 100h for moving to upper, lower, left and right directions to select functions provided in the video reproducing apparatus.

FIG. 4A illustrates the remote controller 100 that is similar to the conventional remote controller. The remote controller 100 converts the channels according to the length of time for which the channel increasing key 100e or the channel decreasing key 100f is pressed.

In contrast, according to the exemplary embodiment of the present invention shown in FIG. 4B, different separations of channel switchover corresponding to the numbers of “+2”, “+4”, “+8”, and “+16”, respectively, are allocated to the respective directional keys 100h corresponding to the upper, lower, left and right directions, and the present channel can be converted according to the separation of channel switchover allocated to the directional keys 100h, respectively. For instance, the channel increase key 100e may be pressed simultaneously with any one of the directional keys 100h, so as to convert the present channel by increasing the present channel according to the separation of channel switchover allocated to the respective directional key that is pressed. Similarly, the channel decrease key 100f may be pressed simultaneously with any one of the directional keys 100h, so as to convert the present channel by decreasing the present channel according to the separation of channel switchover allocated to the respective directional key that is pressed.

FIG. 4C illustrates another exemplary embodiment of the present invention in which a remote controller is provided with high-speed channel switchover keys 100i. In this case, the channel increase key 100e may be pressed simultaneously with any one of the high-speed channel switchover keys 100i so as to convert the present channel by increasing the present channel according to the separation of channel switchover allocated to the respective high-speed channel switchover key that is pressed. Likewise, the channel decrease key 100f may be pressed simultaneously with any one of the high-speed channel switchover keys 100i so as to convert the present channel by decreasing the present channel according to the separation of channel switchover allocated to the respective high-speed channel switchover key that is pressed.

By way of illustration, if it is assumed that the present channel number is “1”, when the high-speed channel switchover key 100h corresponding to the number “+2” is pressed, the present channel number is converted to the channel number “3”, and then “5”, “7”, etc., in turn, and, for instance, when the high-speed channel switchover key 100h corresponding to the number “+4” is pressed, the present channel number is converted to the channel number “5”, and then “9”, and “13”, etc., in turn.

Additionally, if it is assumed that the present channel number is “1”, when the high-speed channel switchover key 100h corresponding to the number ‘+8’ is pressed, the present channel number is converted to the channel number “9”, and then “17”, “25”, etc., in turn, and, for example, when the high-speed channel switchover key 100h corresponding to the number ‘+16’ is pressed, the present channel number is converted to the channel number “17”, and then “33”, and “493”, etc., in turn.

In one exemplary embodiment of the present invention, either the channel increase key 100e or the channel decrease key 100f is simultaneously pressed with one of the high-speed channel switchover keys 100i. However, high-speed channel switchover keys 100i for converting the channels in a channel-increasing direction and/or in a channel-decreasing direction may be provided instead, and, thus, the high-speed channel switchover may be performed through the pressing of the respective high-speed channel switchover keys 100i only.

Although in one exemplary embodiment of the present invention, four separations of channel switchover corresponding to the numbers of “+2”, “+4”, “+8”, and “+16”, respectively, are allocated to the respective directional keys as illustrated in FIGS. 4B and 4C, the present invention is not limited thereto, and more or less directional keys, of various separations of channel switchover, may be provided consistent with the present invention.

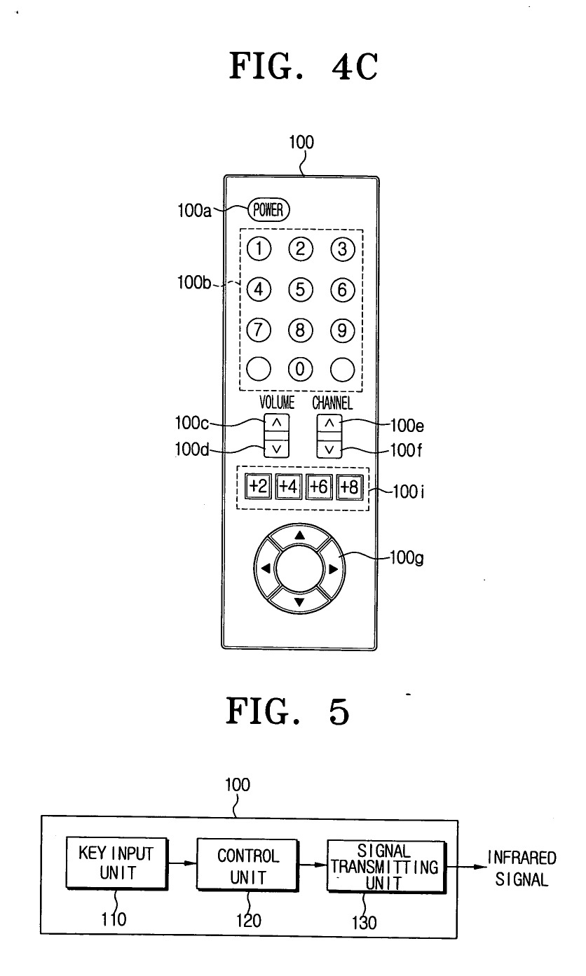

FIG. 5 is a block diagram of a remote controller consistent with an exemplary embodiment of the present invention.

The remote controller 100 according to one exemplary embodiment of the present invention includes a key input unit 110, a control unit 120, and a signal transmitting unit 130.

The key input unit 110, as shown in FIGS. 4A to 4C, is provided with a plurality of function keys including the power supply key 100a, the numeral keys 100b, the channel increase key 100e, the channel decrease key 100f, and the directional keys 100g, and applies request signals corresponding to the function keys selected by the user's key manipulation to the control unit 120.

In one exemplary embodiment of the present invention, the request signals applied from the key input unit 110 to the control unit 120 are diverse request signals for controlling the video reproducing apparatus, including a plural-channel switchover request signal.

In the case of using the remote controller 100 of FIG. 4A, for example, the plural-channel switchover request signal is applied according to the length of time for which the user continuously presses the channel increasing key 100e or the channel decreasing key 100f, which are provided in the remote controller 100.

In the case of using the remote controller 100 of FIG. 4B, for instance, the plural-channel switchover request signal is applied by the user's pressing of either the channel increasing key 100e or the channel decreasing key 100f simultaneously with one of the directional keys 100h, provided in the remote controller 100. In this example, different separations of channel switchover are allocated to the respective directional keys 100h of upper, lower, left and right directions.

In the case of using the remote controller of FIG. 4C, for example, the plural-channel switchover request signal is applied by the user's pressing of either the channel increasing key 100e or the channel decreasing key 100f simultaneously with one of the high-speed channel switchover keys 100i provided in the remote controller 100.

If the plural-channel switchover request signal for converting the channels according to the separation of channel switchover is input from the key input unit 110, the control unit 230 creates a plural-channel switchover code for converting the present channel of the video reproducing apparatus 200 according to the specified separation of channel switchover.

In the case of using the remote controller 100 of FIG. 4A, for instance, the control unit 120 creates and outputs a new plural-channel switchover code that increases the separation of channel switchover, if the created plural-channel switchover request signal is continuously applied for a specified length of time.

For example, if a specified length of time elapses in the state that the user continuously presses the channel increasing key 100e, the key input unit 110 transmits the plural-channel switchover request signal to the control unit 120, and the control unit 120 creates and outputs the plural-channel switchover code having the separation of channel switchover of “+2”.

Thereafter, if the user continues to press the channel increase key 100e, the control unit 120 creates and outputs the plural-channel switchover code having the separation of channel switchover of “+4” after a predetermined time elapses. As described above, if the plural-channel switchover request signal is continuously applied, the control unit 120 increases the separation of channel switchover in accordance with the time for which the channel increase key 100e is continuously pressed.

If the plural-channel switchover request signal is input from the key input unit 210, the control unit 120 creates and outputs a channel information display code for indicating channel information that includes the channel number, after the channel switchover, and the separation of channel switchover, to the video reproducing apparatus 200. The user can recognize the channel number, after the channel switchover, and the separation of channel switchover displayed through the video reproducing apparatus 200.

The signal transmitting unit 130 converts the plural-channel switchover code and the channel information display code output from the control unit 120 into infrared signals, and outputs the infrared signals to the video reproducing apparatus 200, so that the channel of the video reproducing apparatus 200 is converted according to the specified separation of channel switchover. The infrared signals output from the signal transmitting unit 130 are transmitted to the signal receiving unit 220 of the video reproducing apparatus 200.

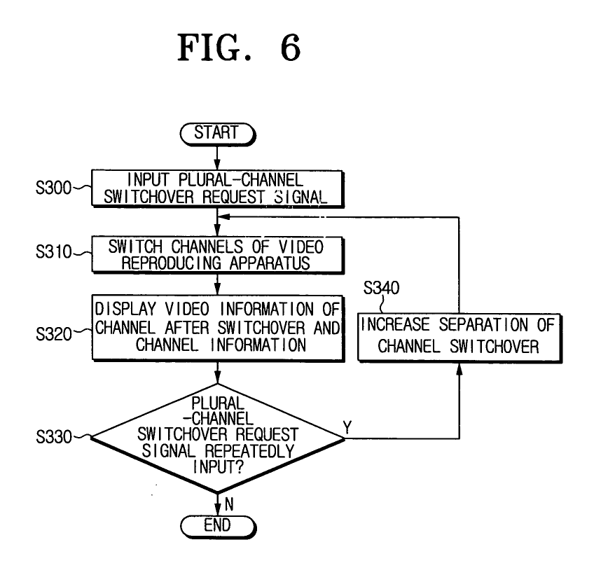

FIG. 6 is a flowchart illustrating a channel converting method for a video reproducing apparatus consistent with an exemplary embodiment of the present invention. A channel converting method for the video reproducing apparatus consistent with an exemplary embodiment of the present invention will now be explained with reference to FIGS. 1 through 3 and FIG. 6.

If the user manipulates the channel increasing key 210a and/or the channel decreasing key 210b provided in the front panel of the video reproducing apparatus 200, the plural-channel switchover request signal from the key input unit 210 is input to the controller 230 (operation S300).

The control unit 230, which receives the plural-channel switchover request signal, controls the channel converting unit 240 to convert the present channel of the video reproducing apparatus 200 according to the specified separation of channel switchover (operation S310).

After the channel converting unit 240 converts the channel of the video reproducing apparatus 200, the control unit 230 operates to display the channel information through the display unit 250. Accordingly, the channel information and the video information of the converted channel are displayed on the display unit 250 (operation S320).

If the plural-channel switchover request signal is repeatedly input from the key input unit 210 (operation S330), the control unit 230 increases the separation of channel switchover according to the input plural-channel switchover request signal (operation S340), and controls the channel converting unit 240 to convert the channel according to the increased separation of channel switchover (operation S310). Then, the operations S310 to S340 are repeatedly performed.

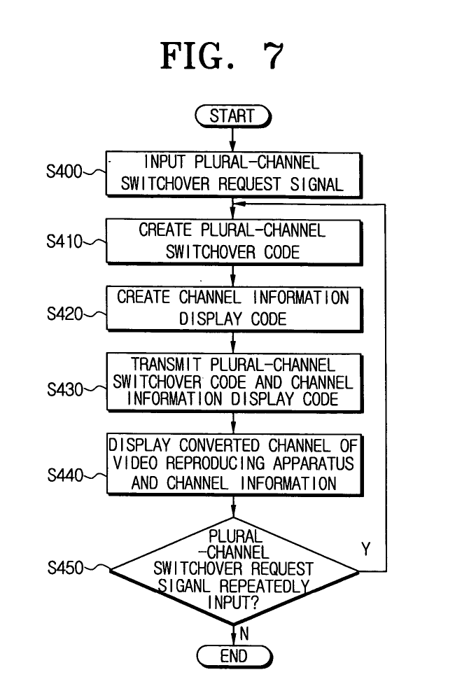

FIG. 7 is a flowchart illustrating a channel converting method for a remote controller consistent with an exemplary embodiment of the present invention. The channel converting method using the remote controller 100 consistent with an exemplary embodiment of the present invention will now be explained with reference to FIGS. 4A through 5 and FIG. 7.

The user can convert the channel using the remote controller 100. If the user manipulates the remote controller 100, the plural-channel switchover request signal is input to the control unit 120 from the key input unit 110 (operation S400).

If the plural-channel switchover request signal is input from the key input unit 110, the control unit 120 creates the plural-channel switchover code corresponding to the plural-channel switchover request signal (operation S410).

Additionally, the control unit 120 may create the channel information display code for displaying the channel information of the video reproducing apparatus 200 (operation S420).

The plural-channel switchover code and the channel information display code created by the control unit 120 are transmitted to the signal transmitting unit 130, and the signal transmitting unit 130 converts the plural-channel switchover code and the channel information display code into infrared signals and outputs the converted infrared signals to the video reproducing apparatus 200 (operation S430).

If the infrared signals are input from the remote controller 100, the video reproducing apparatus 200 converts the channel in accordance with the plural-channel switchover code, and displays the channel, after the channel switchover, and the separation of channel switchover (operation S440).

If the plural-channel switchover request signal is repeatedly input (operation S450), the control unit 120 creates a new plural-channel switchover code corresponding to the input plural-channel switchover request signal, and transmits the new plural-channel switchover code to the video reproducing apparatus 200 through the signal transmitting unit 130.

If the user cannot find the desired channel after the channel switchover, the user searches for the desired channel again by manipulating the remote controller 100. If the user manipulates the remote controller 100, the plural-channel switchover request signal is input to the control unit 120, and the operations S410 to S450 are repeatedly performed.

Generally, most channels are grouped by genre. For example, sport channels generally correspond to the channel numbers of the one hundreds, movie channels generally correspond to the channel numbers of the two hundreds, cultural channels generally correspond to the channel numbers of the three hundreds, cartoon channels generally correspond to the channel numbers of the four hundreds, etc.

Thus, by way of illustration, if a user, who intends to view sports news, already knows the channel number that broadcasts the sports news, the user may directly input the corresponding channel number using the numeral keys 100b, or may promptly convert the present channel to the channel number of the one hundreds according to the channel converting method consistent with an exemplary embodiment of the present invention.

After the channel is converted to the channel number of the one hundreds, the desired channel can be selected more promptly using the channel increase key 10e and the channel decrease key 100f.

Although in one exemplary embodiment of the present invention, the plural-channel switchover is performed by the combination of either the channel increase key 100e or the channel decrease key 100f, and one of the directional keys 100g, the present invention is not limited thereto.

For example, the plural-channel switchover can be performed by a combination comprising any of the volume increase key 100c, the volume decrease key 10d, and the directional keys 100g, instead of the channel increase key 10e and the channel decrease key 100f.

Further, as described above, consistent with an exemplary embodiment of the present invention, a faster channel selection can be achieved by the plural-channel switchover using the existing front panel and the remote controller without any separate keys for channel switchover.

The foregoing illustrative embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims. The principles and features of this invention may be employed in many varied and numerous embodiments without departing from the scope of the present invention and many alternatives, modifications, and variations will be apparent to those skilled in the art.

What is claimed is:

1. A video reproducing apparatus comprising:
a key input unit comprising a plurality of function keys including a channel increase key and a channel decrease key, wherein said key input unit applies request signals corresponding to the function keys;
a channel converting unit which converts a present channel to a desired channel; and
a control unit which controls the channel converting unit to convert the present channel according to a specified separation of channel switchover if a plural-channel switchover request signal, for converting the present channel according to the specified separation of channel switchover, is input to the control unit from the key input unit.

2. The video reproducing apparatus as claimed in claim 1, wherein the plural-channel switchover request signal is applied to the control unit according to a specified length of time for which one of the channel increase key and the channel decrease key is continuously pressed.

3. The video reproducing apparatus as claimed in claim 2, wherein if the plural-channel switchover request signal is continuously applied for the specified length of time, the control unit increases the specified separation of channel switchover.

4. The video reproducing apparatus as claimed in claim 1, wherein if the plural-channel switchover request signal is input, the control unit displays channel information.

5. The video reproducing apparatus as claimed in claim 4, wherein the channel information includes a channel number, after the channel is converted, and the separation of channel switchover.

6. A remote controller for remotely controlling a video reproducing apparatus, comprising:
a key input unit comprising a plurality of function keys including a channel increase key, a channel decrease key, and a plurality of directional keys, which apply request signals corresponding to the function keys;
a control unit for generating a plural-channel switchover code which converts a present channel of the video reproducing apparatus according to a specified separation of channel switchover if a plural-channel switchover request signal for converting the present channel according to the specified separation of channel switchover is input to the control unit from the key input unit; and
a signal transmitting unit which transmits the plural-channel switchover request signal from the control unit to the video reproducing apparatus.

7. The remote controller as claimed in claim 6, wherein the plural-channel switchover request signal is applied to the control unit according to a specified time for which one of the channel increase key and the channel decrease key is continuously pressed.

8. The remote controller as claimed in claim 7, wherein if the plural-channel switchover request signal is continuously applied for the specified time, after the plural-channel switchover code is generated by the control unit, the control unit generates a new plural-channel switchover code that increases the specified separation of channel switchover.

9. The remote controller as claimed in claim 6, wherein the directional keys are provided in correspondence to upper, lower, left and right directions; and
wherein different separations of channel switchover are allocated to the respective directional keys.

10. The remote controller as claimed in claim 9, wherein the plural-channel switchover request signal is applied by pressing the channel increase key or the channel decrease key, and any one of the directional keys.

11. The remote controller as claimed in claim 6, wherein the key input unit further comprises at least one high-speed channel switchover key, which applies the plural-channel switchover request signal for converting the present channel according to the specified separation of channel switchover.

12. The remote controller as claimed in claim 11, wherein the plural-channel switchover request signal is applied by pressing the channel increase key or the channel decrease key, and any one of the high-speed channel switchover keys.

13. The remote controller as claimed in claim 6, wherein if the plural-channel switchover request signal is input to the control unit, the control unit generates a channel information display code for displaying channel information through the video reproducing apparatus and transmits the channel information display code to the video reproducing apparatus through the signal transmitting unit.

14. The remote controller as claimed in claim 13, wherein the channel information includes a channel number, after the channel is converted, and the separation of channel switchover.

15. A method for converting channels of a video reproducing apparatus, comprising:
receiving an input comprising a plural-channel switchover request signal for converting the channels according to a specified separation of channel switchover; and
converting a present channel of the video reproducing apparatus according to the specified separation of channel switchover.

16. The method as claimed in claim 15, further comprising increasing the specified separation of channel switchover if the plural-channel switchover request signal is continuously applied for a specified length of time.

17. The method as claimed in claim 15, further comprising displaying channel information on the video reproducing apparatus if the plural-channel switchover request signal is input.

18. The method as claimed in claim 17, wherein the channel information includes a channel number, after the channel is converted, and the separation of channel switchover.

19. A method for converting channels of a video reproducing apparatus, comprising:
receiving an input of a plural-channel switchover request signal for converting the channels according to a specified separation of channel switchover;
generating a first plural-channel switchover code for converting a present channel of the video reproducing apparatus according to the specified separation of channel switchover; and
transmitting the first plural-channel switchover code to the video reproducing apparatus.

20. The method as claimed in claim 19, further comprising generating a second plural-channel switchover code that increases the separation of channel switchover, if the plural-channel switchover request signal is continuously applied for a specified length of time.

21. The method as claimed in claim 20, further comprising:
generating a channel information display code for displaying channel information through the video reproducing apparatus; and
transmitting the channel information display code to the video reproducing apparatus if the plural-channel switchover request signal is input.

22. The method as claimed in claim 21, wherein the channel information includes a channel number, after the channel is converted, and the separation of channel switchover.

23. The remote controller as claimed in claim 10, wherein the plural-channel switchover request signal is applied by pressing the channel increase key or the channel decrease key simultaneously with any one of the directional keys.

24. The remote controller as claimed in claim 10, wherein the plural-channel switchover request signal is applied by pressing and releasing a directional key, and then pressing one of the channel increase key and the channel decrease key.

25. The remote controller as claimed in claim 12, wherein the plural-channel switchover request signal is applied by pressing the channel increase key or the channel decrease key simultaneously with any one of the high-speed channel switchover keys.

26. The remote controller as claimed in claim 12, wherein the plural-channel switchover request signal is applied by pressing and releasing a high-speed channel switchover key, and then pressing one of the channel increase key and the channel decrease key.
